(19) United States
(12) Patent Application Publication
(10) Pub. No.: US 2006/0284935 A1
(43) Pub. Date: Dec. 21, 2006

(54) Inkjet printer head and fabrication method thereof

(76) Inventors: Yong-shik Park, Seongnam-si (KR); Myong-jong Kwon, Suwon-si (KR); Sung-joon Park, Suwon-si (KR); Jin-wook Lee, Seoul (KR)

Correspondence Address: STANZIONE & KIM, LLP, 919 18TH STREET, N.W., SUITE 440, WASHINGTON, DC, 20006, US

(21) Appl. No.: 11/404,803

(22) Filed: Apr. 17, 2006

(30) Foreign Application Priority Data
Jun. 21, 2005 (KR) 2005-53458

(51) Int. Cl. B41J 2/05

(52) U.S. Cl. 347/61

(57) ABSTRACT

An inkjet printer head and fabrication method thereof. The inkjet printer head includes a substrate, a thermal layer formed on the substrate to generate thermal energy, a first electrode formed on the thermal layer except at a nozzle forming portion of the thermal layer, and a second electrode extending a predetermined distance to the nozzle forming portion of the thermal layer from a top portion of the first electrode to contact a central portion of the thermal layer. Accordingly, the inkjet printer head has high efficiency and durability.

### CROSS-REFERENCE TO RELATED APPLICATIONS

This application claims the benefit under 35 U.S.C. § 119 of Korean Patent Application No. 2005-53458 filed on Jun. 21, 2005, in the Korean Intellectual Property Office, the disclosure of which is incorporated herein in its entirety.

### BACKGROUND OF THE INVENTION

1. Field of the Invention

The present general inventive concept relates to an inkjet printer head and a fabrication method thereof. More particularly, the present general inventive concept relates to an inkjet printer head which can protect an electrode from ink as ink directly contacts a heater.

2. Description of the Related Art

As computers are popularized, peripheral devices also come into wide use. Among the peripheral devices, new types of printers, such as a digital laser printer, have been developed and continue to expand in use. However, since the digital laser printer is very expensive for an individual to purchase, the inkjet printer, which is relatively inexpensive, is generally used by individuals.

The inkjet printer ejects ink droplets onto a paper through nozzles by using a printer head to print images. There are various methods for ejecting ink onto the paper in the inkjet printer. A thermal transfer ink ejecting method is typically employed, which generates heat from a thermal layer to form bubbles in an ink chamber containing ink and ejects ink through nozzles.

A substrate, a thermal layer, an electrode, a passivation layer, and an anti-cavitation layer are sequentially deposited to form the conventional inkjet printer head. More particularly, the electrode is formed in a central portion of the substrate except for a portion where a nozzle is formed, and the passivation layer and the anti-cavitation layer are formed on the thermal layer and the electrode to protect the thermal layer and the electrode.

The passivation layer electrically insulates the thermal layer and protects the thermal layer from outer impact, and the anti-cavitation layer protects the thermal layer from damage caused by a cavitation force generated as the ink bubbles disappear. The ink bubbles are produced by thermal energy.

However, ink cannot contact the thermal layer due to the passivation layer and the anti-cavitation layer so that heat is lost and thermal efficiency decreases. This will be explained with reference to FIG. 1.

FIG. 1 is a graph illustrating a temperature distribution in each layer of the conventional inkjet printer head according to driving conditions.

Referring to FIG. 1, the temperature is highest in the thermal layer TaN and gradually decreases towards the substrate Si. Since the temperature slope is the steepest in the passivation layer SiNx and SiOx, the biggest heat loss is generated in the passivation layer SiNx and SiOx, and since the temperature slope is gentle in the anti-cavitation layer Ta, the heat loss is rarely generated in the anti-cavitation layer Ta.

For example, if the printer is driven by 10V, as the energy of 0.64 μs is supplied to increase the temperature to 300 degrees for forming ink bubbles in an interface contacting the ink, the temperature of the thermal layer increases up to 760 degrees, and the temperature difference of 460 degrees is lost due to the decreased thermal efficiency.

To prevent the heat loss due to the passivation layer, the passivation layer and the anti-cavitation layer may be formed thinly or removed.

If the passivation layer and the anti-cavitation layer are removed, the heat loss can be prevented to increase the thermal efficiency. However, aluminum Al, which is typically used for the electrode, is chemically very unstable so as to be easily damaged when exposed to the ink. Therefore, the lifespan of the electrode may be shortened.

Additionally, if aurum (gold) Au or platinum Pt, which are chemically stable with respect to the ink, is used for the electrode to solve the disadvantageous effects of the aluminum, the Au or Pt should be used for via-structures and logic portions connected with other electrode layers. The Au or Pt are chemically stable with respect to ink, however, narrow line widths can not be easily realized using the Au or Pt and high-integrated small print heads can not be manufactured.

### SUMMARY OF THE INVENTION

The present general inventive concept provides an inkjet printer head which forms a second electrode to protect a first electrode such that a thermal layer directly contacts ink, and the first electrode can be protected from the ink, and a method of fabrication thereof.

Additional aspects and utilities of the present general inventive concept will be set forth in part in the description which follows and, in part, will be obvious from the description, or may be learned by practice of the general inventive concept.

The foregoing and/or other aspects of the present general inventive concept are achieved by providing an inkjet printer head including a substrate, a thermal layer formed on the substrate to generate thermal energy, a first electrode formed on the thermal layer except at a nozzle forming portion of the thermal layer, and a second electrode extending a predetermined distance to the nozzle forming portion of the thermal layer from a top portion of the first electrode to contact a central portion of the thermal layer.

The inkjet printer head may further include a passivation layer formed on a portion of the first electrode where the second electrode is not formed.

The second electrode may be made of a chemically stable material with respect to ink.

The first electrode and the second electrode may be made of different metals. The first electrode may be made of aluminum Al, and the second electrode may be made of one of aurum (gold) Au, tantalum Ta, and platinum Pt.

The foregoing and/or other aspects of the present general inventive concept are also achieved by providing an inkjet printer head, including a substrate, a thermal layer formed on the substrate to heat ink and having a nozzle forming portion through which the ink passes, a first conductive metal layer formed on the thermal layer except at the nozzle forming portion to transmit electrical signals to the thermal layer, and a second conductive metal layer formed on the first conductive metal layer and a portion of the nozzle forming portion of the thermal layer to prevent the ink from contacting the first conductive metal layer.

The foregoing and/or other aspects of the present general inventive concept are also achieved by providing an inkjet printer head, including a thermal layer to directly contact ink and to generate heat to heat the ink, and an electrode portion having a first electrode layer to transmit electrical signals to the thermal layer, and a second electrode layer to protect the second electrode layer from the ink.

The foregoing and/or other aspects are also achieved by providing a fabrication method of an inkjet printer head, including forming a thermal layer on a substrate to generate thermal energy, forming a first electrode on the thermal layer except at a nozzle forming portion of the thermal layer, and forming a second electrode to extend a predetermined distance into the nozzle forming portion of the thermal layer from a top portion of the first electrode to contact a central portion of the thermal layer.

The method may further include forming a passivation layer on the first electrode to protect the first electrode after forming the first electrode.

The forming of the second electrode may include forming the second electrode to extend from a top portion of the passivation layer and the top portion of the first electrode the predetermined distance into the nozzle forming portion.

The second electrode may be made of a chemically stable material with respect to ink.

The first electrode and the second electrode may be made of different metals.

The first electrode may be made of aluminum Al, and the second electrode may be made of one of aurum (gold) (Au), Tantalum (Ta), and Platinum (Pt).

The foregoing and/or other aspects of the present general inventive concept are also achieved by providing a fabrication method of an inkjet print head, including depositing a thermal layer on a substrate, depositing a first conductive material on the thermal layer to supply electrical signals to the thermal layer, removing a portion of the first conductive metal to expose a nozzle forming area of the thermal layer through which in passes, and depositing a second conductive metal on a portion of the first conductive metal and a portion of the exposed nozzle forming area of the thermal layer to prevent the ink from contacting the first conductive metal.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a graph illustrating a temperature distribution in each layer of a conventional inkjet printer head;

FIG. 2 is a sectional view illustrating an inkjet printer head according to an embodiment of the present general inventive concept;

FIGS. 3A and 3B are sectional views illustrating inkjet printer heads according to other embodiments of the present general inventive concept;

FIG. 4 is a process view illustrating a fabrication method of the inkjet printer head of FIG. 3A according to an embodiment of the present general inventive concept; and

FIG. 5 is a process view illustrating a fabrication method of the inkjet printer head of FIG. 3B according to another embodiment of the present general inventive concept.

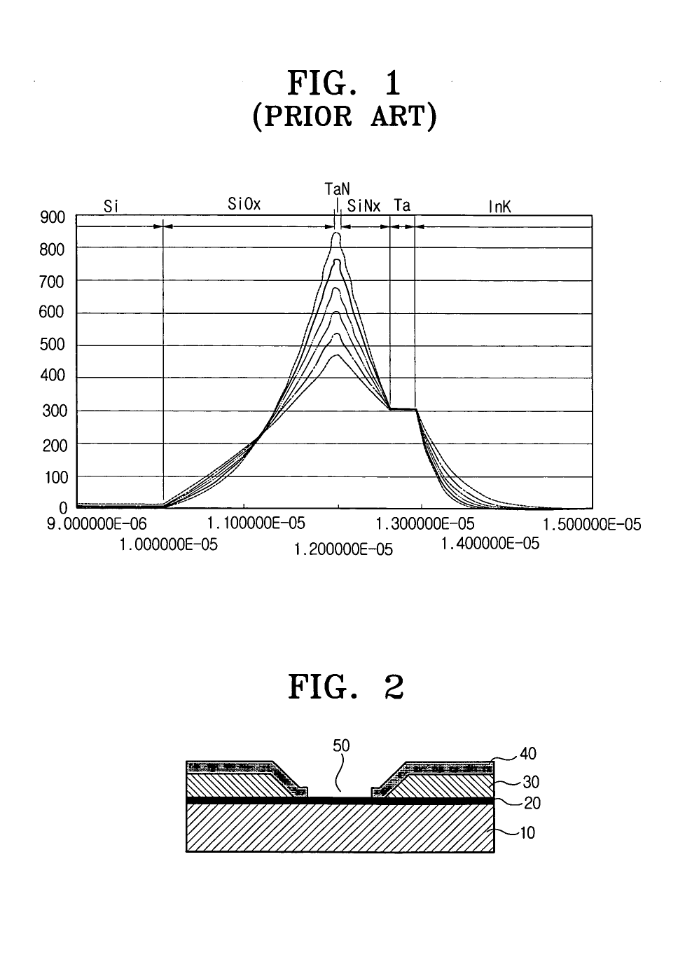

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a cross-sectional view illustrating an inkjet printer head according to an embodiment of the present general inventive concept.

Referring to FIG. 2, the inkjet printer head upwardly ejects ink according to a thermal transfer method, and comprises a substrate 10, a thermal layer 20, a first electrode 30, and a second electrode 40. The substrate 10 may be made of Silicon Si.

The thermal layer 20 is a thin film heater formed on the substrate 10, and converts electrical signals received from the first electrode 30 into thermal energy to generate heat to instantly heat ink. The thermal layer 20 may be made of a metallic material, such as Aluminum Tantalum Ta—Al, nitride Tantalum TaN, Silicon Aluminum Tantalum Ta—Al—Si, and Poly Silicon Poly-Si.

The first electrode 30 is formed on the thermal layer 20 except at a nozzle forming portion 50 of the thermal layer 20 where a circular viahole nozzle is formed. The first electrode 30 can receive the electrical signals from CMOS (Complementary Metal Oxide Semiconductor) logic (not shown) and a power transistor (not shown), and transmits the electrical signals to the thermal layer 20. The first electrode 30 may be made of Aluminum Al, which has a high electric conductivity.

The second electrode 40 extends a predetermined distance into the nozzle forming portion 50 from a top portion of the first electrode 30 to contact a central portion of the thermal layer 20. Since the second electrode 40 contacts the thermal layer 20, the first electrode 30 is not exposed to the ink at the nozzle forming portion 50 such that the first electrode 30 can be protected from the ink.

According to the present embodiment, the first electrode 30 and the second electrode 40 can be made of different metals. Additionally, the second electrode 40 can be made of a chemically stable material with respect to the ink since the second electrode 40 directly contacts the ink at the nozzle forming portion 50. For example, if the first electrode 30 is made of Al, the second electrode 40 may be made of one of Au, Ta, and Pt.

In a fabrication process of the inkjet printer head of FIG. 2, one of Ta—Al, TaN, Ta—Al—Si and Poly-Si is deposited on the substrate 10 to form the thermal layer 20.

Al is deposited on the thermal layer 20 to form the first electrode 30, and a portion of the first electrode 30 corresponding to the nozzle forming portion 50 is etched away. One of Au, Ta, and Pt is then deposited on the first electrode 30 and the thermal layer 20 to form the second electrode 40, and a central portion of the second electrode 40 is etched away by a certain width at the nozzle forming portion 50 such that the thermal layer 20 is exposed at part of the nozzle forming portion 50 and covered by the second electrode 40 at another part of the nozzle forming portion 50.

As described above, the substrate 10, the thermal layer 20, the first electrode 30, and the second electrode 40 are sequentially deposited to form the inkjet printer head, and the second electrode 40 covers the first electrode 30 such that the first electrode 30 is not exposed to the ink at the nozzle forming portion 50. Accordingly, a lifespan of the first electrode 30 can be extended.

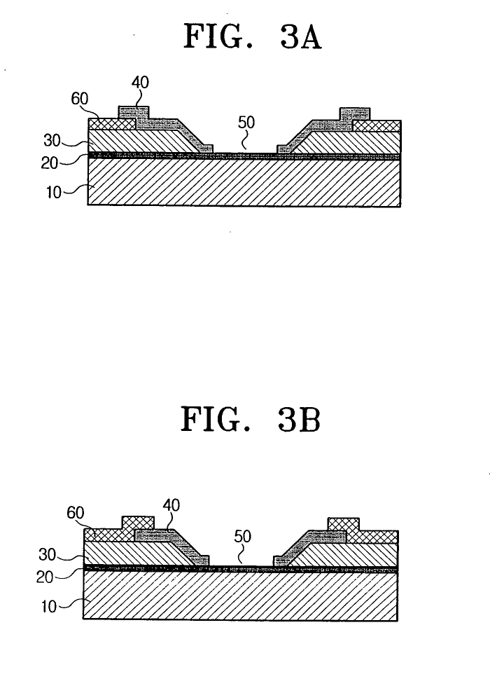

FIGS. 3A to 3B are views illustrating inkjet printer heads according to other embodiments of the present general inventive concept.

The inkjet printer heads of FIGS. 3A and 3B have similar structures with the inkjet printer head of FIG. 2, however, a passivation layer 60 to insulate the thermal layer 20 is further included in each of the inkjet printer heads of FIGS. 3A and 3B.

Similar to the inkjet printer head of FIG. 2, the inkjet printer heads of FIGS. 3A and 3B include the thermal layer 20 formed on the substrate 10 to generate thermal energy, and the first electrode 30 formed on the thermal layer 20 except at the nozzle forming portion 50. When forming the second electrode 40 on the first electrode 30, the passivation layer 60 is further included. Only different constructions from FIG. 2 will be explained hereinafter, and the same constructions will be omitted for the sake of brevity.

The passivation layer 60 contacts the first electrode 30 and the second electrode 40 to electrically insulate the thermal layer 20 and to protect the thermal layer 20 from outer impact. The passivation layer 60 may be formed of SiNx or SiOx, which have excellent insulation capabilities and thermal transfer efficiencies.

Referring to FIG. 3A, the thermal layer 20 is formed on the substrate 10, the first electrode 30 is formed on the thermal layer 20, and the passivation layer 60 is formed on the first electrode 30. The second electrode 40 is then formed over the passivation layer 60 and the first electrode 30 and extends into the nozzle forming portion 50 by a certain distance.

FIG. 3B is a view illustrating a transformed example of the inkjet head of FIG. 3A. Referring to FIG. 3B, the thermal layer 20 is formed on the substrate 10, the first electrode 30 is formed on the thermal layer 20, and the second electrode 40 extends by the certain distance from the top portion of the first electrode 30 to the nozzle forming portion 50. The passivation layer 60 is then formed over the first electrode 30 and the second electrode 40.

FIGS. 3A and 3B illustrate exemplary structures of the inkjet printer head, in which the passivation layer 60 is formed before forming the second electrode 40 or after forming the second electrode 40, respectively. Accordingly, the structure of the passivation layer 60 is not limited and may vary according to when the passivation layer 60 is formed.

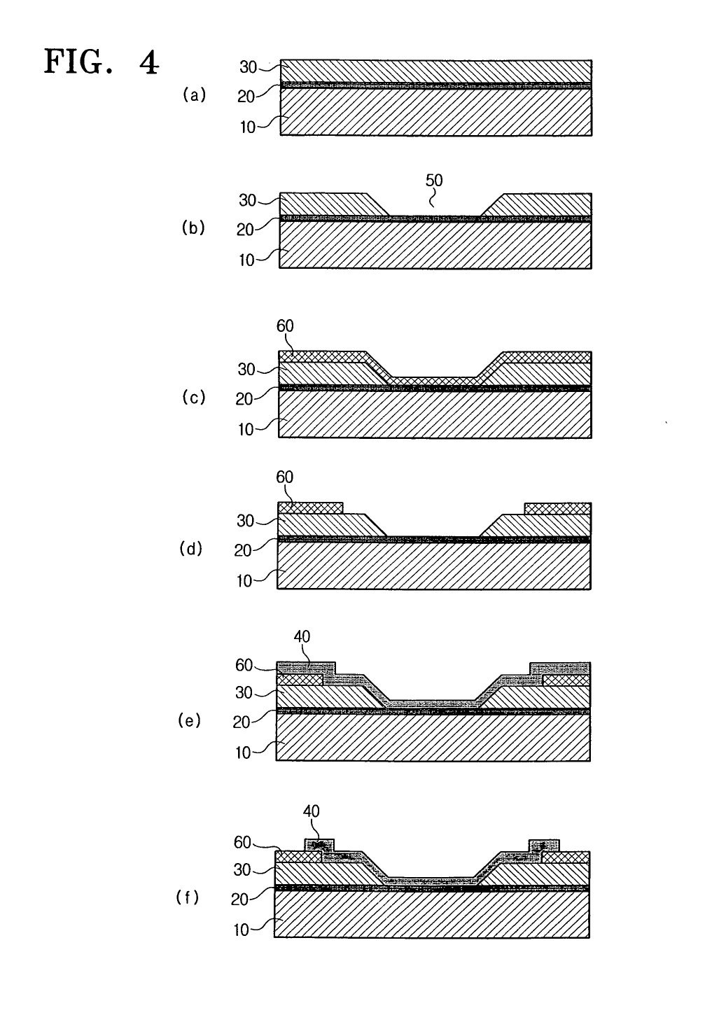

FIG. 4 is a process view illustrating a fabrication method of the inkjet printer head of FIG. 3A according to an embodiment of the present general inventive concept. Referring to FIGS. 3A and 4, the fabrication method will be explained in which the substrate 10, the thermal layer 20, the first electrode 30, the passivation layer 60, and the second electrode 40 are sequentially deposited to form the inkjet printer head.

As illustrated in FIG. 4(a), the thermal layer 20 with a predetermined thickness is deposited on the substrate 10 to generate thermal energy, and the first electrode 30 with a predetermined thickness is deposited on the thermal layer 20 to supply the electric signals to the thermal layer 20.

A portion of the first electrode 30 corresponding to the nozzle forming portion 50 is then etched away from the first electrode 30 to form the pattern of the first electrode 30 as illustrated in FIG. 4(b).

The passivation layer 60 is then deposited on the thermal layer 20 and the first electrode 30 as illustrated in FIG. 4(c).

A part of the passivation layer 60 is etched away from the nozzle forming portion 50 to expose a predetermined part of the first electrode 30 as illustrated in FIG. 4(d). By this process, the passivation layer 60 is formed to extend by a predetermined distance inward from an edge of the top portion of the first electrode 30.

The second electrode 40 is then deposited on the passivation layer 60, the first electrode 30, and the nozzle forming portion 50 of the thermal layer 20 as illustrated in FIG. 4 (e). The second electrode 40 can be made of a different material from the first electrode 30.

As illustrated in FIG. 4(f), the second electrode 40 is etched away from the edge of a top portion of the passivation layer 60 inward by a predetermined distance. As illustrated in FIG. 4(f), the second electrode is formed in a pattern to cover the first electrode 30 on the nozzle forming portion 50.

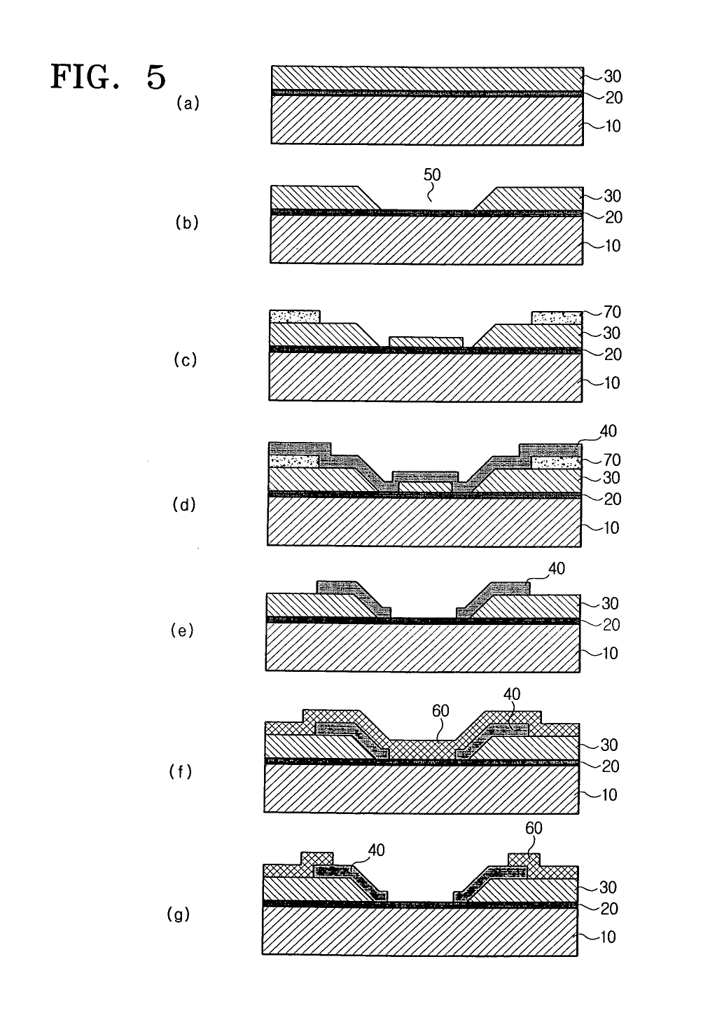

FIG. 5 is a process view illustrating a fabrication method of the inkjet printer head of FIG. 3B according to another embodiment of the present general inventive concept. Referring to FIGS. 3B and 5, the fabrication method will be explained hereinafter in which the substrate 10, the thermal layer 20, the first electrode 30, the second electrode 40, and the passivation layer 60 are sequentially deposited to form the inkjet printer head. Some of operations of the fabrication method of FIG. 5 are similar to the operations of the fabrication method of FIG. 4.

As illustrated in FIG. 5(a), the thermal layer 20 with a predetermined thickness is deposited on the substrate 10, and the first electrode 30 with a predetermined thickness is deposited on the thermal layer 20.

A central portion of the first electrode 30, corresponding to the nozzle forming portion 50, is etched away to form the pattern of the first electrode 30 as illustrated in FIG. 5(b).

A photoresist film 70 is then formed on predetermined portions of the nozzle forming portion 50 and the first electrode 30 as illustrated in FIG. 5(c).

The second electrode 40 is then formed on the photoresist film 70, the first electrode 30, and the nozzle forming portion 50 of the thermal layer 20 as illustrated in FIG. 5(d). The photoresist film 70 is then removed to form the pattern of the second electrode 40 as illustrated in FIG. 5(e).

The passiviation layer 60 is then formed on the first electrode 30, the second electrode 40, and the nozzle forming portion 50 of the thermal layer 20 as illustrated in FIG. 5(f). The passivation layer 60 is etched away except for a part contacting both of the first electrode 30 and the second electrode 40. By this process, the inkjet printer head is formed as illustrated in FIG. 5(g).

As described above, in the embodiments of the inkjet printer head including the substrate 10, the thermal layer 20, the first electrode 30, the second electrode 40, and the passivation layer 60, the second electrode 40 protects the first electrode 30 from directly contacting ink at the nozzle forming portion 50 such that the lifespan of the first electrode 30 can be extended. Although heat loss may slightly occur due to the passivation layer 60, the thermal layer 20 can be protected from outer impact by the passivation layer 60. Furthermore, since the thermal layer 20 directly contacts the ink at the nozzle forming portion 50, a thermal efficiency of the inkjet printer head is increased.

As illustrated in FIGS. 4 and 5, the inkjet printer head formed in the order of the second electrode 40 and the passivation layer 60 has the same effect with that formed in the order of the passivation layer 60 and the second electrode 40.

As described above, in an inkjet printer head and the fabrication method thereof according to the embodiments of the present general inventive concept, a second electrode covers a first electrode and is made of chemically stable material so as to protect the first electrode from directly contacting ink. Accordingly, damage of the first electrode can be prevented and a lifespan of the first electrode can be extended. Also, the inkjet printer head has high efficiency and durability.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer head comprising:
a substrate;
a thermal layer formed on the substrate to generate thermal energy;
a first electrode formed on the thermal layer except at a nozzle forming portion of the thermal layer; and
a second electrode extending a predetermined distance to the nozzle forming portion of the thermal layer from a top portion of the first electrode to contact a central portion of the thermal layer.

2. The inkjet printer head according to claim 1, further comprising:
a passivation layer formed on a portion of the first electrode where the second electrode is not formed.

3. The inkjet printer head according to claim 2, wherein the passivation layer is formed between the portion of the first electrode where the second electrode is not formed and the second electrode.

4. The inkjet printer head according to claim 2, wherein the passivation layer is formed on the portion of the first electrode where the second electrode is not formed and on a portion of the second electrode adjacent to the portion of the first electrode where the second electrode is not formed.

5. The inkjet printer head according to claim 1, wherein the second electrode is made of a chemically stable material with respect to ink.

6. The inkjet printer head according to claim 1, wherein the first electrode and the second electrode are made of different metals.

7. The inkjet printer head according to claim 6, wherein the first electrode is made of aluminum Al.

8. The inkjet printer head according to claim 6, wherein the second electrode is made of one of aurum Au, tantalum Ta, and platinum Pt.

9. An inkjet printer head, comprising:
a substrate;
a thermal layer formed on the substrate to heat ink and having a nozzle forming portion through which the ink passes;
a first conductive metal layer formed on the thermal layer except at the nozzle forming portion to transmit electrical signals to the thermal layer; and
a second conductive metal layer formed on the first conductive metal layer and a portion of the nozzle forming portion of the thermal layer to prevent the ink from contacting the first conductive metal layer.

10. The inkjet print head according to claim 9, further comprising a passivation layer to contact the first and second conductive metal layer to insulate the thermal layer.

11. An inkjet print head, comprising:
a thermal layer to directly contact ink and to generate heat to heat the ink; and
an electrode portion having a first electrode layer to transmit electrical signals to the thermal layer, and a second electrode layer to protect the first electrode layer from the ink.

12. The inkjet print head according to claim 11, wherein the first and second electrode layers are made of different conductive metals.

13. The inkjet print head according to claim 11, wherein the first electrode layer is chemically unstable with respect to the ink and the second electrode layer is chemically stable with respect to the ink.

14. A fabrication method of an inkjet printer head comprising:
forming a thermal layer on a substrate to generate thermal energy;
forming a first electrode on the thermal layer except at a nozzle forming portion of the thermal layer; and
forming a second electrode to extend a predetermined distance into the nozzle forming portion of the thermal layer from a top portion of the first electrode to contact a central portion of the thermal layer.

15. The method according to claim 14, further comprising:
forming a passivation layer on the first electrode to protect the first electrode after forming the first electrode.

16. The method according to claim 15, wherein forming of the second electrode comprises:
forming the second electrode to extend from a top portion of the passivation layer and the top portion of the first electrode the predetermined distance into the nozzle forming portion.

17. The method according to claim 14, wherein the second electrode is made of a chemically stable material with respect to ink.

18. The method according to claim 14, wherein the first electrode and the second electrode are made of different metals.

19. The method according to claim 18, wherein the first electrode is made of aluminum Al.

20. The method according to claim 18, wherein the second electrode is made of one of aurum (Au), Tantalum (Ta), and Platinum (Pt).

21. The method according to claim 14, further comprising:
forming a passivation layer on a portion of the first electrode and the second electrode after forming the second electrode.

22. The method according to claim 21, wherein the forming of the second electrode comprises:
forming a photoresist film on predetermined portions of the first electrode and the nozzle forming portion of the thermal layer;
forming the second electrode of the photoresist film, the first electrode and the nozzle forming portion of the thermal layer; and
removing the photoresist film to expose the predetermined portions of the first electrode and the nozzle forming portion of he thermal layer.

23. The method according to claim 22, wherein the forming of the passivation layer comprises:
forming the passivation layer on the exposed predetermined portion of the first electrode and on a portion of the second electrode adjacent to the exposed predetermined portion of the first electrode.

24. A fabrication method of an inkjet printer head, the method comprising:
depositing a thermal layer on a substrate;
depositing a first conductive material on the thermal layer to supply electrical signals to the thermal layer;
removing a portion of the first conductive metal to expose a nozzle forming area of the thermal layer through which in passes; and
depositing a second conductive metal on a portion of the first conductive metal and a portion of the exposed nozzle forming area of the thermal layer to prevent the ink from contacting the first conductive metal.
